(19) United States
(12) Patent Application Publication
(10) Pub. No.: US 2021/0048238 A1
(43) Pub. Date: Feb. 18, 2021

(54) HOUSING FOR ELECTRIC APPARATUS, REFRIGERATION CYCLE APPARATUS, AND ELECTRIC APPARATUS

(71) Applicant: Mitsubishi Electric Corporation, Tokyo (JP)

(72) Inventors: Susumu FUJIWARA, Tokyo (JP); Kazuya MICHIKAMI, Tokyo (JP)

(21) Appl. No.: 16/978,888

(22) PCT Filed: Apr. 25, 2018
(86) PCT No.: PCT/JP2018/016810

§ 371 Date: Sep. 8, 2020

(51) Int. Cl. F25D 19/00; G10K 11/162

(52) U.S. Cl. CPC F25D 19/00; F25D 2201/30; F25B 2500/12; G10K 11/162

(57) ABSTRACT

A housing for an electric apparatus includes a housing body and a silencer. The housing body has a space provided to house a device that is a noise source and at least one opening communicating the space. The silencer is attached to an outer periphery of the housing body in such a manner as to surround the opening.

### TECHNICAL FIELD

The present disclosure relates to a housing for an electric apparatus, which includes a housing body having an air inlet and an air outlet, a refrigeration cycle apparatus including the housing, and an electric apparatus including the refrigeration cycle apparatus.

### BACKGROUND ART

In general, a refrigeration cycle apparatus includes a load side unit, such as an indoor unit, and a heat-source-side unit, such as an outdoor unit. The load side unit and the heat-source-side unit each include a housing body that houses, for example, a fan, a compressor, or a motor that is a noise source. Also, in general, the housing body has an air inlet through which air is sucked into the housing body and an air outlet through which air is blown out of the housing body. At the air inlet and the air outlet of the housing body, the flow of a fluid, such as air, causes disturbance of an acoustic phenomenon, that is, it makes noise.

For example, Patent Literature 1 proposes a technique in which a duct-shaped sound reducing structure including a sound absorbing layer is provided in a flow passage to reduce noise. To be more specific, in the technique disclosed in Patent Literature 1, a duct through which a fluid flows is formed to have a double-pipe structure including an outer pipe and a perforated inner pipe such that a space between the outer pipe and the inner pipe is filled with a sound absorber to reduce sound.

For example, Patent Literature 2 discloses a technique in which a frequency band in which sound can be reduced is widened, whereby even if a load state of a fan changes, noise can be reduced. To be more specific, a space between a casing and an orifice plate is filled with a sound absorber to reduce sound.

Patent Literature 3 proposes a technique in which there are provided a unit housing having an air inlet face and an air outlet face and a plurality of fans arranged in series at regular intervals in an air passage in the unit housing, and in the air passage in the unit housing, a silencer is provided.

### CITATION LIST

### Patent Literature

Patent Literature 1: Japanese Unexamined Patent Application Publication No. 2005-220871

Patent Literature 2: Japanese Patent No. 5353137

Patent Literature 3: Japanese Unexamined Patent Application Publication No. 2008-269193

### SUMMARY OF INVENTION

### Technical Problem

In all the configurations disclosed in the above literatures, the turbulence of the fluid is reduced in an air passage to reduce the turbulence of the acoustic phenomenon, that is, to reduce noise, thereby improving the acoustic phenomenon.

However, in order to reduce the turbulence of the fluid in the air passage, it is necessary to increase the length of a duct for passage adjustment. If a space where the housing body is installed is tight such that there is no room for provision of a structure, such as a duct, the passage itself needs to be changed, and necessary measures against noise are not taken.

The present disclosure is applied to solve the above problem, and relates to a housing for an electric apparatus, at which the acoustic characteristics of noise made by sound amplification that occurs in a housing body can be attenuated, a refrigeration cycle apparatus, and an electric apparatus.

### Solution to Problem

A housing for an electric-apparatus, according to an embodiment of the present disclosure, includes a housing body and a silencer. The housing body has a space provided to house a device that is a noise source and at least one opening communicating the space. The silencer is attached to an outer periphery of the housing body in such a manner as to surround the opening.

### Advantageous Effects of Invention

In the housing for the electric apparatus, according to the embodiment of the present disclosure, the silencer is attached to the outer periphery of the housing body in such a manner as to surround the opening through which a fluid flows. Because of provision of such a configuration, it is possible to attenuate the acoustic characteristics of noise made by sound amplification that occurs in the housing body.

### BRIEF DESCRIPTION OF DRAWINGS

FIG. 1 is a schematic diagram illustrating an internal configuration of a housing that is a common example of a housing.

FIG. 2 is a graph illustrating examples of analyzed radiation and internal acoustic characteristics at an air inlet, an air outlet, and a central portion of the housing of FIG. 1.

FIG. 3 is a reference diagram explaining “standing waves” in acoustic spaces.

FIG. 4 is a schematic diagram illustrating an internal configuration of a housing according to an embodiment of the present disclosure.

FIG. 5 is a vertical sectional view schematically illustrating an example a sectional configuration of a silencer provided at the housing according to the embodiment of the present disclosure.

FIG. 6 is a graph showing examples of measured acoustic absorptivities of materials that can be applied to a sound absorber.

FIG. 7 is a vertical sectional view schematically illustrating another example of the sectional configuration of the silencer provided at the housing according to the embodiment of the present disclosure.

FIG. 8 is a schematic diagram illustrating an example of the configuration of the housing according to the embodiment of the present disclosure.

FIG. 9 is a schematic diagram illustrating a modification of the housing according to the embodiment of the present disclosure.

FIG. 10 is a schematic diagram illustrating another modification of the housing according to the embodiment of the present disclosure.

FIG. 11 a schematic diagram illustrating still another modification of the housing according to the embodiment of the present disclosure.

FIG. 12 a schematic diagram illustrating a further modification of the housing according to the embodiment of the present disclosure.

FIG. 13 a schematic diagram illustrating a still further modification of the housing according to the embodiment of the present disclosure.

### DESCRIPTION OF EMBODIMENTS

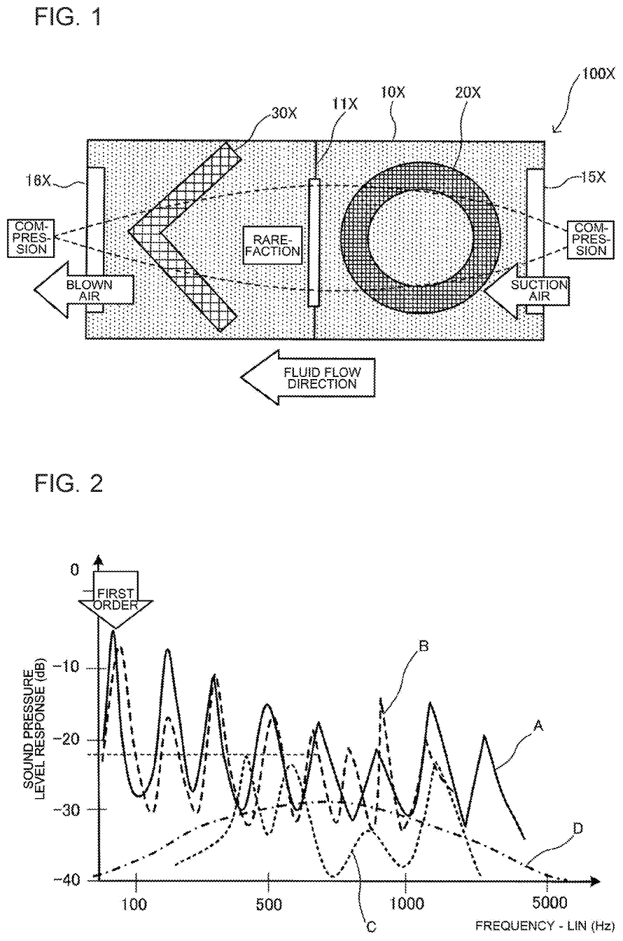

An embodiment of the present disclosure will be described with reference to the drawings. It should be noted that the relationship in size between components as illustrated in the following figures including FIG. 1 may differ from the relationship between actual components. Furthermore, in each of the following figures including FIG. 1, components that are the same as or equivalent to those in a previous figure are denoted by the same reference signs. The same is true of the entire text of the specification. In addition, examples of the forms of components are described in the specification, that is, the forms of the components are not limited to those described in the specification.

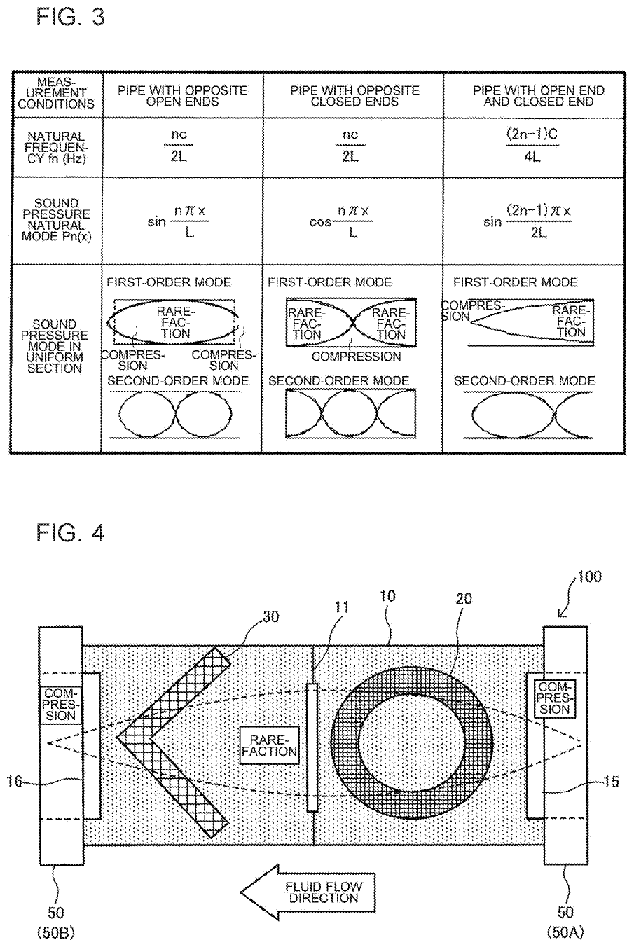

First, “resonance” that is primarily caused by an acoustic phenomenon that occurs in the configuration of a housing in which a fluid flows will be described with reference to FIGS. 1 to 3. FIG. 1 is a schematic diagram illustrating an internal configuration of a housing 100X that is a common example of a housing. FIG. 2 is a graph illustrating examples of analyzed radiation and internal acoustic characteristics at an air inlet, an air outlet, and a central portion of the housing of FIG. 1. FIG. 3 is a reference diagram explaining “standing waves” in acoustic spaces.

In FIG. 1, broken lines represent the phase of sound. In FIG. 2, the vertical axis represents a sound pressure level response (dB) and the horizontal axis represents a frequency (Hz). In FIG. 2, a line A represents the frequency characteristics of a standing wave at an air inlet 15X, a line B represents the frequency characteristics of the standing wave at an air outlet 16X, a line C represents the frequency characteristics of the standing wave at the central portion of a housing body 10X, and a line D represents the frequency characteristics of a fluid that flows in the housing 100X. The frequency characteristics indicated in FIG. 3 have already been known.

FIG. 1 illustrates an example in which the housing 100X of an electric apparatus is a housing of a common indoor unit of an air-conditioning apparatus that is one of refrigeration cycle apparatuses.

As illustrated in FIG. 1, the housing 100X includes the housing body 10X, which forms an outer shell of the housing 100X and is shaped in the form of a box having a space therein. The housing body 10X houses a fan 20X, which is an example of a device that is a noise source, and a heat exchanger 30X. The internal space of the housing body 10X is divided by a partition 11X. The fan 20X is located upstream of the partition 11X in the flow direction of the fluid. The heat exchanger 30X is located downstream of the partition 11X in the flow direction of the fluid. The housing body 10X has the air inlet 15X and the air outlet 16X as openings.

As indicated by the broken lines in FIG. 1, sound amplification occurs as a phenomenon at each of the air inlet 15X and the air outlet 16X of the housing 100X. As indicated by the lines A and B in FIG. 2, the result of analysis of an acoustic phenomenon in a sound field measured in the housing body 10X indicates that a standing-wave state appears at each of the air inlet 15X and the air outlet 16X. A standing wave is composed of compressional waves.

As illustrated in FIG. 1, a standing wave amplified at a frequency that is obtained by using formulas in the reference diagram of FIG. 3 and that depends on the size of the housing body 10X The fluid has frequency characteristics in a wide frequency band, in which no characteristic peak component is present, like white noise. Characteristic frequency amplification is caused which depends on a size determined by the formulas in the reference diagram of FIG. 3, and sound compressional waves are certainly present in the housing body 10X.

The compressional waves depend on the structure of the housing body 10X. In the housing 100X having the air inlet 15X and the air outlet 16X, the compressional waves have “antinodes” at the air inlet 15X and the air outlet 16X. In other words, the compressional waves having maximum sound pressures at the air inlet 15X and the air outlet 16X are present in the housing 100X. Such a phenomenon determines the frequency characteristics of noise. The noise is radiated as sound from each of the air inlet 15X and the air outlet 16X.

FIG. 4 is a schematic diagram illustrating an internal configuration of a housing 100 according to an embodiment of the present disclosure. The housing 100 will be described with reference to FIG. 4. The housing 100 is designed to reduce the sound pressure amplification caused by the “antinodes” of compressional waves at an air inlet 15 and an air outlet 16. In the following description, the air inlet 15 and the air outlet 16 may be referred to as openings.

The housing 100 includes a box-shaped housing body 10 that forms an outer shell of the housing 100. The housing body 10 houses a fan 20 and a heat exchanger 30. An internal space of the housing body 10 is divided by a partition 11. The fan 20 is located upstream of the partition 11 in the flow direction of a fluid. The heat exchanger 30 is located downstream of the partition 11 in the flow direction of the fluid. The housing body 10 has the air inlet 15 and the air outlet 16 as openings. The fan 20 may be located downstream of the heat exchanger 30. The type of the fan 20 is not limited to a specific one. Also, the type of the heat exchanger 30 is not limited to a specific one.

The housing 100 has the same basic configuration as the housing 100X as illustrated in FIG. 1. In the housing 100, at the air inlet 15 and the air outlet 16, respective silencers 50 are provided. In this regard, the housing 100 is different from the housing 100X. As a matter of convenience for explanation, in the figures, the silencer 50 located at the air inlet 15 is indicated as a silencer 50A and the silencer 50 located at the air outlet 16 is indicated as a silencer 50B. However, in the following, in the case where it is not necessary to distinguish the silencers 50A and 50B from each other, they are described as the silencers 50.

The silencer 50A is provided at an outer periphery of the housing body 10 in such a manner as to surround the air inlet 15 formed as the opening. Therefore, the silencer 50A is formed to have an inner surface over which the fluid flows. The shape of the silencer 50A is not limited to a specific one. For example, the silencer 50A can be formed in the shape of a ring having a reference length in the flow direction of the fluid and in such a manner as to surround the air inlet 15. The length of the silencer 50A in the flow direction of the fluid will be described later.

The silencer 50B is provided at the outer periphery of the housing body 10 in such a manner as to cover the opening corresponding to the air outlet 16. Therefore, the silencer 50B is formed to have an inner surface over which the fluid flows. The shape of the silencer 50B is not limited to a specific one. For example, the silencer 50B can be formed in the shape of a ring having a reference length in the flow direction of the fluid and in such a manner as to surround the air outlet 16. It should be noted that the silencer 50B may have the same configuration as that of the silencer 50A or may have a configuration different from that of the silencer 50A. The length of the silencer 50B in the flow direction of the fluid will be described later.

Assuming that the space in the housing body 10 has a dimension of 0.5 m, a first-order component of a standing wave can be calculated from FIG. 1 as follows. Where F is the frequency (Hz) of the first-order component, C is the speed of sound (340 m at 20 degrees C.), and L is the dimension (m) of the space in the housing body 10, and the dimension of the space in the housing body 10 means the length of part of the space that is parallel to the flow direction of the fluid, the frequency F can be obtained from FIG. 3, using the formula “F=C/(2×L)”. In other words, F=340 m/(2×0.5)=340 Hz.

This frequency is a peak frequency. Order components of the frequency, that is, odd-order components, are radiated from the air inlet 15 and the air outlet 16. For the frequencies of fluid components that are noise sources, the fluid components have broad frequency characteristics in a band ranging from approximately 500 Hz or less to approximately 5000 Hz, as indicated by the line D in FIG. 2.

The standing wave further has frequencies depending on the width of the housing body 10 and frequencies depending on the height of the housing body 10 as well as frequencies depending on the entire length of the housing body 10. Assuming that the width is 0.8 m, the frequencies depending on the width that can cause sound amplification are 212.5 Hz, 637.5 Hz, 1062.5 Hz, and 1487.5 Hz. Assuming that the height is 0.2 m, the frequencies depending on the height that can cause sound amplification are 850 Hz and 2550 Hz. In order ratio, the frequencies of even-order components cancel each other out in phase of sound. Therefore, the generation of these components as sound may be prevented from occluding as an acoustic phenomenon. Therefore, it is conceivable that it is important how to deal especially with the odd-order components.

In consideration of frequency components associated with rotation of the fan 20 as well as the above calculation, it is important how to deal with at least frequency components ranging from 637.5 to 1700 Hz. The “antinodes” of sound waves that form a standing wave substantially coincide with the positions of the air inlet 15 and the air outlet 16 of the housing body 10. However, in an environment at an actual place where the housing body 10 is provided, an internal pressure of the housing body 10 is slightly different from a pressure at the place where the housing body 10 is provided. To be more specific, the housing body 10 is often designed to be compact in size in consideration of the place where the housing body 10 is provided. The internal pressure of the housing body 10 is often not coincident with the pressure at the place where the housing body 10 is provided, for example, an indoor pressure.

If the internal pressure of the housing body 10 and the pressure at the place where the housing body 10 is provided are constant, a linear attenuation in sound pressure level will occur from an immediate vicinity of each of the air inlet 15 and the air outlet 16 of the housing body 10. However, since the internal pressure of the housing body 10 is higher than the pressure at the place where the housing body 10 is provided as described above, compression part of each of sound waves radiated from the housing body 10 is present in a region from a position close to the housing body 10 to a location where a pressure coincides with the internal pressure of the housing body 10. That is, the compression part of the sound waves is present in a region a little far from the air inlet 15 and the air outlet 16 of the housing body 10.

In this case, the positions a little far from the air inlet 15 and the air outlet 16 of the housing body 10 are positions located apart from the air inlet 15 and the air outlet 16 by approximately 5 to 10 cm in respective directions away from the housing body 10. The “antinodes”, at which sound is amplified at maximum, are located at the above positions. In view of this, at the housing 100, the silencers 50 are provided at positions located outward of the air inlet 15 and the air outlet 16, where the antinodes of the sound waves are present. Since the antinodes of the sound waves are present at positions located apart from the air inlet 15 and the air outlet 16 by approximately 5 to 10 cm in respective directions away from the housing body 10, the silencers 50 are each formed such that the length of part of each silencer 50 over which the fluid flows is 10 cm or less.

The silencer 50 will be described in detail.

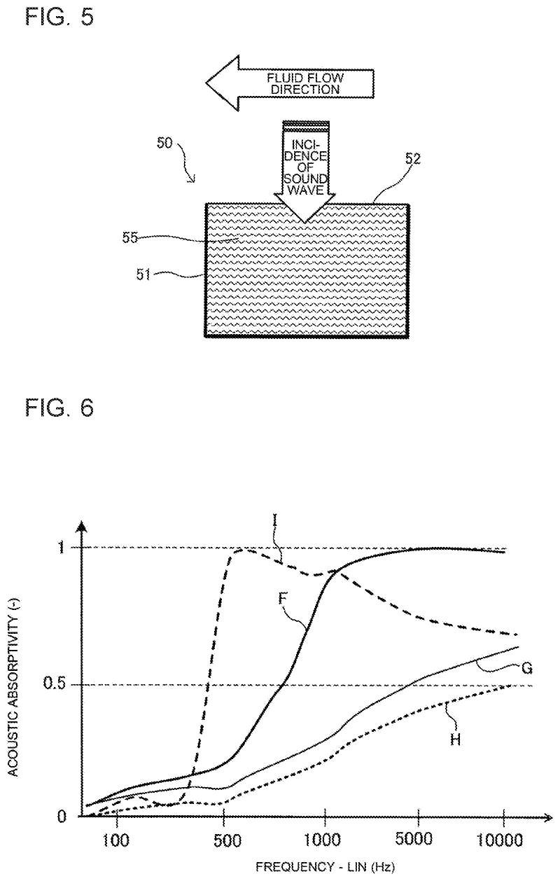

FIG. 5 is a vertical sectional view schematically illustrating an example of a sectional configuration of the silencer 50 provided at the housing 100. FIG. 6 is a graph indicating examples of measured acoustic absorptivities of materials that can be each applied as material of a sound absorber 55. In FIG. 6, the vertical axis represents the acoustic absorptivity and the horizontal axis represents the frequency. FIG. 6 is a graph of an example in which all the materials have a thickness of 20 mm. In FIG. 6, a line F represents the acoustic absorptivity of pulp fibers, a line G represents that of felt nonwoven fabric, a line H represents that of foam chemical fibers, and a line I represents that of a thin film of pulp fibers.

As illustrated in FIG. 5, the silencer 50 includes a casing 51 and the sound absorber 55 filled into the casing 51. The casing 51 is made of, for example, metal or resin, and forming an outer shell of the silencer 50. A side of the casing 51 is open, and on this side, the fluid flows. The other sides of the casing 51 are closed. The sound absorber 55 functions to deplete acoustic energy as heat energy. When the sound absorber 55 is attached to the casing 51, part of the sound absorber 55 over which the fluid flows is exposed.

The sound absorber 55 is required to have air chambers for efficient energy conversion. As indicated by the line F in FIG. 6, the pulp fibers can ensure an acoustic absorptivity of 0.5 or more at 600 Hz. However, as indicated by the line G in FIG. 6, the acoustic absorptivity that the felt nonwoven fabric can ensure at 600 Hz is only approximately 0.2. As indicated by the line H in FIG. 6, the acoustic absorptivity that the foam chemical fiber fabric can ensure at 600 Hz is only approximately 0.1.

It can be understood from the above that the pulp fibers can be effectively used as material of the sound absorber 55. This is because each pulp fiber itself has many hollow walls. In other words, the sound absorber 55 made of pulp fibers can achieve more efficient energy conversion, because the air chambers are easily ensured and the hollow walls of the pulp fibers also effectively contribute to the energy conversion. However, the material of the sound absorber 55 is not limited to the pulp fibers. The sound absorber 55 can be made of another material other than the pulp fibers as long as the material can reliably form a sound absorbing layer.

Because of the function of the sound absorber 55, the silencer 50 can deplete as heat energy, the acoustic energy of “sound=noise”, which is produced by standing wave components. The sound absorber 55 is made to have a thickness that is greater than or equal to ¼ wavelength, in order for the sound absorber 55 to deplete acoustic energy by thermal conversion. To be more specific, assuming that the frequency of acoustic energy to be depleted is 500 Hz, the sound absorber 55 is required to have a thickness of 0.2 m or less because C=f×λ where C is the speed of sound, f is the frequency, and λ is a single wavelength.

It is conceivable that it the case where the space where the housing 100 is provided is small, it may be impossible to form a sound absorber 55 such that the sound absorber 55 has a thickness of 0.2 m. To be more specific, in the case where the size of the space where the housing 100 is actually provided is only approximately 0.05 m, the thickness of the sound absorber 55 cannot be set to 0.2 m. However, even in such a case, the silencer 50 is required to be designed to efficiently deplete acoustic energy as heat energy. In view of this point, the sound absorber 55 is made of a thin film of pulp fibers formed by, for example, compression shaping. In this case, the sound absorber 55 exhibits a high acoustic absorptivity as represented by the line I in FIG. 6, though the sound absorber 55 is made thin.

In the case where pulp fibers are uses as the material of the sound absorber 55, the sound absorber 55 can be formed to have a thickness of approximately 0.02 m. In the case where the sound absorber 55 has a thickness of approximately 0.02 m, even if the size of the space where the housing 100 is provided is approximately 0.05 m, the silencer 50 can be attached to the housing body 10. Thus, since as described above, the sound absorber 55 exhibits a high sound absorbing effect even if the thickness of the sound absorber 55 is approximately 0.02 m, the sound absorber 55 can sufficiently attenuate sound radiation components.

The silencer 50 formed in the above manner is provided at a position where “compression” part of radiated sound waves is present. As a result, a standing wave in the internal space of the housing body 10, or a resonance component, enters the sound absorber 55 included in the silencer 50. The side of the casing 51 that the sound wave enters is open, but the other sides of the casing 51 are completely closed. The inside of the casing 51 does not communicate with an outside space, except the above open side of the casing 51. That is, sound that enters the silencer 50 does not leak from the silencer 50 to the outside, and noise that enters the silencer 50 from the outside space is not transmitted to the housing body 10.

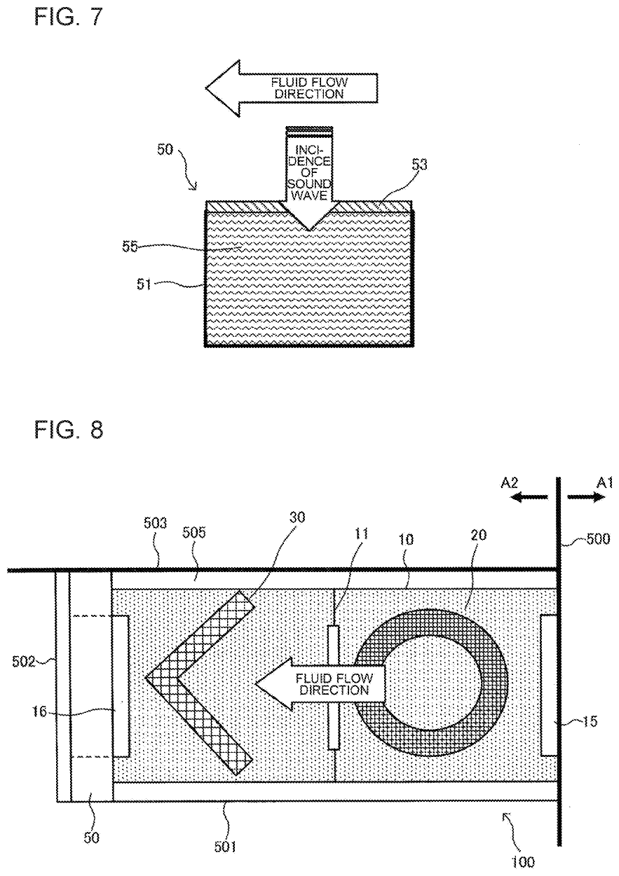

FIG. 7 is a longitudinal sectional view schematically illustrating another example of the sectional configuration of the silencer 50 provided at the housing 100. FIG. 8 is a schematic diagram illustrating an example of the configuration of the housing 100. A modification of the silencer 50 will be described with reference to FIGS. 7 and 8.

An exposure surface of the sound absorber 55 is exposed to the fluid. Thus, the material that forms the sound absorber 55 can scatter. Therefore, as illustrated in FIG. 7, a moisture permeable membrane 53 may be provided on the exposure surface of the sound absorber 55 such that the sound absorber 55 is covered with the moisture permeable membrane 53. The moisture permeable membrane 53 can reduce scattering of the material that forms the sound absorber 55. In the case where the moisture permeable membrane 53 is formed, pulp fibers may be used as a main component.

Since the moisture permeable membrane 53 is made of pulp fibers that are also applied to the sound absorber 55, the moisture permeable membrane 53 can be easily coupled to the sound absorber 55. It is therefore unnecessary to use, for example, an adhesive layer at the time of forming layers. In other words, it is unnecessary to use, for example, an adhesive agent for coupling the moisture permeable membrane 53 to the sound absorber 55. If the moisture permeable membrane 53 is made of material different from the material of the sound absorber 55, an adhesive agent is used. Since the adhesive agent enters the material that forms the sound absorber 55 and that is originally formed as an air layer, the air layer is filled with the adhesive agent. Consequently, air chambers, which are necessary for the sound absorber 55, are eliminated from the sound absorber 55, and the effect of the sound absorber 55 is reduced.

In contrast, in the case where the moisture permeable membrane 53 is formed as the same material as the sound absorber 55, it is unnecessary to use an adhesive agent as described above. Accordingly, needless to say, the air chambers are not closed by an adhesive agent, and the effect of the sound absorber 55 is not reduced. Furthermore, the thickness of the moisture permeable membrane 53 can be adjusted in the range of, for example, 20 to 100μ, in consideration of a frequency band in which an sound absorbing effect is achieved.

There is a case where by changing the thickness of the membrane on the exposure surface of the sound absorber 55, the membrane vibrates, and sound radiation components can be effectively attenuated to be vibrated only in a specific frequency band. This phenomenon is called “membrane sound absorption”, and can be utilized at the silencer 50 to effectively attenuate sound radiation components at specific frequencies. In addition, by using the membrane sound absorption in the silencer 50, an acoustic attenuation effect can be achieved for low-frequency components, which are difficult to deal with in intrinsic wavelength. Since in a low frequency band, the wavelength is long, acoustic energy components in the low frequency band are larger than those in a high-frequency band. It is conceivable that the entire surface formed as the membrane is vibrated by low-frequency acoustic energy, and low-frequency components can be effectively attenuated.

Even in the case where the sound absorber 55 is provided in a wet space such as a space above a ceiling, aged deterioration of the sound absorber 55 can be reduced by performing at least one of antifungal treatment, antimicrobial treatment, moisture-proof treatment, and flame-retardant treatment to the sound absorber 55. The casing 51 may be made of the same material as the housing body 10, for example, metal or resin. The casing 51 may be made of any material as long as the casing 51 can be made to be in a hermetic state such that the outside and the inside of the silencer 50 does not communicate with each other. The casing 51 may have any shape and any size as long as the casing 51 has a length and a thickness that are required for the configuration of the silencer 50.

Although FIG. 4 illustrates the configuration in which to the air inlet 15 and the air outlet 16, the respective silencers 50 are attached, one silencer 50 may be attached to only one of the air inlet 15 and the air outlet 16 in a given environment where a countermeasure against noise is taken. For example, as illustrated in FIG. 8, the silencer 50 may be attached only to the air outlet 16 in an environment where the air inlet 15 communicates with a corridor A1 and the air outlet 16 communicates with a room A2. Because of this configuration, it is possible to reliably attenuate sound radiated from the air outlet 16 in the room A2 that communicates with the air outlet 16.

FIG. 8 illustrates an example in which a rear portion of the housing 100 is fixed to a wall 500 of the room A2. To be more specific, the housing 100 is provided in a space 505 surrounded by the wall 500, a ceiling 503, a bottom panel 501, and a front panel 502. The housing 100 communicates with the room A2 via the air outlet 16. The front panel 502, which is located adjacent to the front of the housing 100, has an opening through which the fluid can pass. The rear portion of the housing 100 is an end of the housing 100 that is adjacent to the corridor A1, and the front of the housing 100 is an end of the housing 100 that is adjacent to the room A2.

### <Modifications>

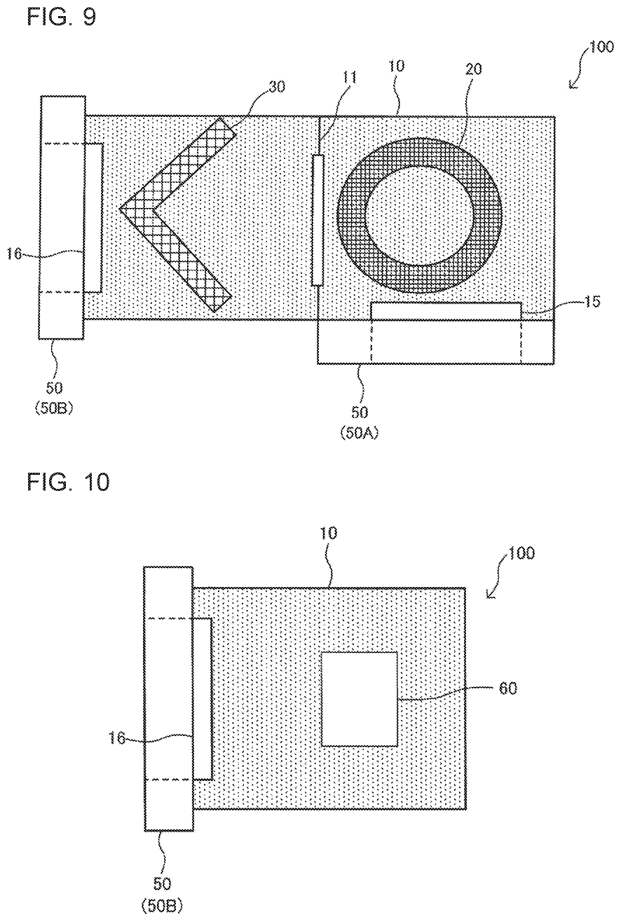

FIGS. 9 to 13 are schematic diagrams illustrating modifications of the housing 100. The modifications of the housing 100 will be described with reference to FIGS. 9 to 13.

FIG. 9 illustrates an example in which the housing 100 is used in a common indoor unit of an air-conditioning apparatus. As illustrated in FIG. 9, the air inlet 15 is provided in part of a side surface of the housing 100 that does not face the air outlet 16. Even in such a housing 100 in which the air inlet 15 does not face the air outlet 16, the silencers 50 is provided, whereby resonance components that generate at the housing body 10 can be attenuated.

FIG. 10 illustrates a case where the housing 100 is applied to an example of a common outdoor unit of an air-conditioning apparatus. As illustrated in FIG. 10, the housing 100 has no air inlet 15. The housing body 10 of the housing 100 houses, for example, a compressor 60. Even in the housing 100 having no air inlet 15, the silencer 50 is provided at the air outlet 16, whereby a resonance component that generates at the housing body 10 can be attenuated.

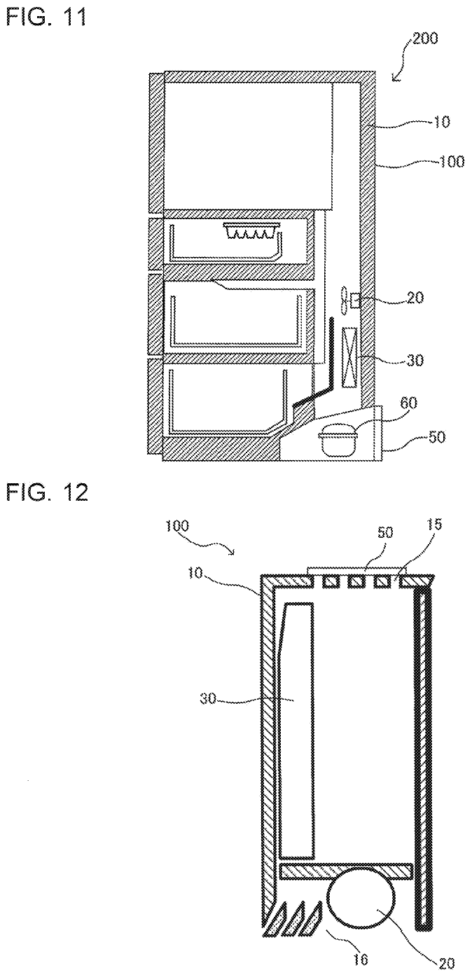

FIG. 11 illustrates the case where the housing 100 is used as a casing of a refrigerator 200. As illustrated in FIG. 11, in the housing body 10 of the housing 100 of the refrigerator 200, the fan 20, the heat exchanger 30, and the compressor 60 are provided. The fan 20 and the compressor 60 are noise sources. Therefore, a standing wave, which is composed of compressional waves, generates in the housing body 10. In other words, even in the case where the housing 100 is used as the casing of the refrigerator 200, the silencer 50 is provided, whereby resonance components that generate at the housing body 10 can be attenuated. It should be noted that the silencer 50 may be attached to at least one of an air inlet and an air outlet, and as illustrated in FIG. 11, the silencer 50 may be attached to an opening of a compression chamber in which the compressor 60 is provided.

FIG. 12 illustrates the case where the housing 100 is applied to another example of the common indoor unit of an air-conditioning apparatus. As illustrated in FIG. 12, the housing 100 has an air inlet 15 formed in a top surface of the housing body 10 and an air outlet 16 formed in a bottom surface of the housing body 10. Even in the housing 100 having the air inlet 15 and the air outlet 16 that are arranged in a height direction of the housing body 10, the silencer 50 is provided, whereby resonance components that generate at the housing body 10 can be attenuated. Although FIG. 12 illustrates an example in which the silencer 50 is provided only at the air inlet 15, the silencer 50 may be provided only at the air outlet 16. Also, at both the air inlet 15 and the air outlet 16, respective silences 50 may be provided.

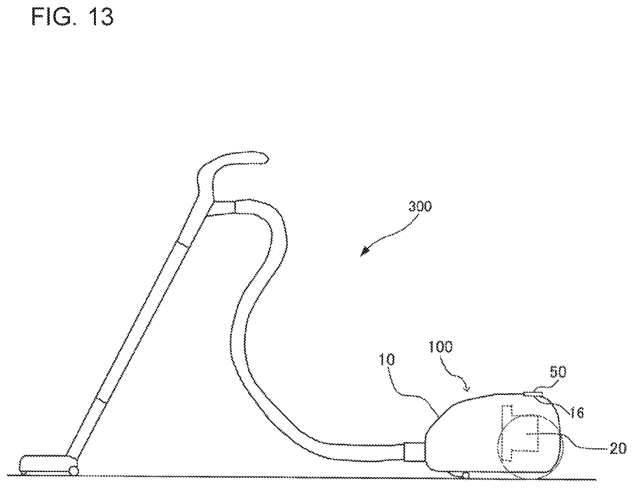

FIG. 13 illustrates the case where the housing 100 is used as a body of a cleaner 300. As illustrated in FIG. 13, the housing body 10 of the housing 100 of the cleaner 300 houses the fan 20. The fan 20 is a noise source. Therefore, a standing wave, which is composed of compressional waves, generates in the housing body 10. In other words, even if the housing 100 is used as the body of the cleaner 300, the silencer 50 is provided, whereby a resonance component that generates at the housing body 10 can be attenuated. The silencer 50 may be provided at an air inlet. Also, at both the air inlet and the air outlet 16, respective silencers 50 may be provided.

As described above, the housing 100 includes: the housing body 10 housing a device that is a noise source and having at least one opening; and the silencer 50 attached to an outer periphery of the housing body 10 in such a manner as to surround the opening in the housing body 10. In the housing 100, the silencer 50 is provided at the opening, which serves as at least one of the air inlet and the air outlet. Because of this configuration, it is possible to effectively attenuate noise made by a fluid radiated from the housing body 10.

The silencer 50, which is provided at the housing body 10 of the housing 100, includes the casing 51 including the open portion over which the fluid flows and the sound absorber 55 filled into the casing 51. In the housing 100, the silencer 50 including the sound absorber 55 is provided and can effectively attenuate noise made in the housing body 10. Additionally, in the housing 100, noise that is radiated from the housing body 10 can be sufficiently reduced even in an environment where a duct cannot be physically provided.

The sound absorber 55 included in the silencer 50 disposed on the housing body 10 of the housing 100 is made of pulp fibers. Therefore, in the housing 100, the pulp fibers, which have many pores, provide higher acoustic absorptivity than a sound absorber made of another fibers exhibits.

The silencer 50 disposed on the housing body 10 of the housing 100 includes the moisture permeable membrane 53 disposed on the exposure surface of the sound absorber 55. Therefore, this arrangement in the housing 100 can hinder the material constituting the sound absorber 55 from scattering.

A refrigeration cycle apparatus includes the housing 100, the fan 20, and the heat exchanger 30 and has openings that are the air inlet 15 and the air outlet 16 of the housing body 10. The silencer 50 is attached to at least one of the air inlet 15 and the air outlet 16. Therefore, the refrigeration cycle apparatus can effectively attenuate noise made by a fluid radiated from the housing body 10.

An electric apparatus including the above refrigeration cycle apparatus can effectively attenuate noise made by a fluid radiated from the housing body 10. Examples of the electric apparatus are an air-conditioning apparatus, a water heating apparatus, a refrigeration apparatus, a dehumidifying apparatus, and a refrigerator.

Although it is described above by way of example that the noise source provided in the housing body 10 is the cleaner or the compressor, it is also conceivable that a motor is another example of the noise source.

### REFERENCE SIGNS LIST

10 housing body 10X housing body 11 partition 11X partition 15 air inlet 15X air inlet 16 air outlet 16X air outlet 20 fan 20X fan 30 heat exchanger 30X heat exchanger 50 silencer 50A silencer 50B silencer 51 casing 53 moisture permeable membrane 55 sound absorber 60 compressor 100 housing 100X housing 200 refrigerator 300 cleaner 500 wall 501 bottom panel 502 front panel 503 ceiling 505 space A1 corridor A2 room

1. A housing for an electric apparatus, comprising:
a housing body having a space and an opening, the space being provided to house a device that is a noise source, the at least one opening communicating with the space; and
a silencer attached to an outer periphery of the housing body in such a manner to surround the at least one opening.

2. The housing of claim 1, wherein the silencer includes:
a casing including an open portion over which a fluid flows; and
a sound absorber filled into the casing.

3. The housing of claim 2, wherein the sound absorber is formed of pulp fibers.

4. The housing of claim 2, wherein the silencer further includes a moisture permeable membrane provided on an exposure surface of the sound absorber.

5. A refrigeration cycle apparatus comprising:
the housing of claim 1;
a fan disposed in the housing body of the housing; and
a heat exchanger provided in the housing body of the housing,
wherein the housing body has an air inlet and an air outlet as the at least one opening, and the silencer is attached to at least one of the air inlet and the air outlet.

6. An electric apparatus comprising:
the refrigeration cycle apparatus of claim 5.
